(19) United States
(12) Patent Application Publication
(10) Pub. No.: US 2020/0360205 A1
(43) Pub. Date: Nov. 19, 2020

(54) Mattress Support for Imparting a Hospital Bed Functionality to a Consumer Bed

(71) Applicant: Hill-Rom Services, Inc., Batesville, IN (US)

(72) Inventors: David Ribble, Indanapolis, IN (US); Kirsten Emmons, Batesville, IN (US); Craig Meyerson, Syracuse, NY (US); Ibne Soreefan, West Chester, OH (US)

(21) Appl. No.: 16/861,983

(22) Filed: Apr. 29, 2020

Related U.S. Application Data
(60) Provisional application No. 62/847,431, filed on May 14, 2019.

(51) Int. Cl. A61G 7/015; A47C 20/04; A61G 7/018

(52) U.S. Cl. CPC A61G 7/015; A61G 7/018; A47C 20/048

(57) ABSTRACT

A mattress support for a bed includes a base plate and an upper plate assembly. The upper plate assembly includes a head plate having a head end and a foot end. The head end of the head plate is hinged to the base plate by a first hinge. The upper plate assembly also includes a foot plate in tandem with the head plate. The foot plate is hinged to the foot end of the head plate by a second hinge which is parallel to the first hinge. An actuator system between the base plate and the upper plate assembly is operable to adjust the upper plate assembly between a planar configuration and a nonplanar configuration.

This application claims priority to U.S. Provisional Application 62/847,431 entitled “Mattress Support for Imparting a Hospital Bed Functionality to a Consumer Bed” filed on May 14, 2019, the contents of which are incorporated herein by reference.

### RELATED APPLICATIONS

Each of the following is incorporated herein by reference in its entirety:
1) U.S. provisional application 62/739,334 filed on Sep. 30, 2018 and titled “PATIENT CARE SYSTEM FOR A HOME ENVIRONMENT”,
2) U.S. provisional application 62/739,337 filed on Sep. 30, 2018 and titled “STRUCTURES FOR CAUSING MOVEMENT OF ELEMENTS OF A BED”,
3) U.S. provisional application 62/739,340 filed on Sep. 30, 2018 and titled “MATTRESS SUPPORT FOR ADDING HOSPITAL BED FUNCTIONALITY TO AN AT-HOME BED”,
4) U.S. provisional application 62/739,344 filed on Sep. 30, 2018 and titled “MODULAR CONTROL SYSTEM FOR UPGRADING A BED TO INCLUDE MOVABLE COMPONENTS”,
5) U.S. provisional application No. 62/567,995 filed Oct. 4, 2017 titled “APPARATUS FOR ADDING HOSPITAL BED FUNCTIONALITY TO AN AT-HOME BED”,
6) U.S. provisional application No. 62/567,275 filed on Oct. 24, 2017 titled “MODULAR TURN ASSIST APPARATUS AND METHOD THEREFOR”.

### TECHNICAL FIELD

The subject matter described herein relates to an apparatus for adding a functionality to a conventional bed which is found only in specially designed hospital beds.

### BACKGROUND

Extended hospitalization of a patient is an ongoing challenge due at least partly to the high cost incurred by the patient and the hospital and also to various disadvantages of hospitalization. At-home care is also challenging due to the high cost, difficulty, and complexity of equipping the home for patient care. While several systems and methods exist for equipping the home for patient care, opportunity exists for continued development in this area.

### SUMMARY

A mattress support for a bed includes a base plate and an upper plate assembly. The upper plate assembly includes a head plate having a head end and a foot end. The head end of the head plate is hinged to the base plate by a first hinge. The upper plate assembly also includes a foot plate in tandem with the head plate. The foot plate is hinged to the foot end of the head plate by a second hinge which is parallel to the first hinge. An actuator system between the base plate and the upper plate assembly is operable to adjust the upper plate assembly between a planar configuration and a nonplanar configuration.

### BRIEF DESCRIPTION OF THE DRAWINGS

The foregoing and other features of the various embodiments of the mattress support described herein will become more apparent from the following detailed description and the accompanying drawings in which:

FIG. 1 is a schematic side elevation view of a conventional bed outfitted with a head end mattress support and a foot end mattress support, the foot end mattress support being the topic of this patent application and imparting to the bed a functionality found only in specially designed hospital beds which have components permanently integrated into them to achieve the functionality.

FIG. 2 is is a view similar to that of FIG. 1 but with the mattress in a non-planar profile due partly to use of the foot end mattress support.

FIG. 3 is a view in the direction 3-3 of FIG. 2 showing an elevation system of the head end mattress support, the elevation system being represented by an embodiment of a bladder array.

FIGS. 4-6 are views similar to those of FIG. 3 showing other embodiments of the bladder array.

FIG. 7 is a perspective view of a modularized embodiment of the head end mattress support.

FIGS. 8A, 8B, and 8C are a schematic side elevation views of the foot end mattress support of FIGS. 1-2 showing an actuator system embodied as a bladder assembly having a single bladder array which drives both a head plate and a foot plate of the mattress support, and showing the bladder array in three different states of inflation.

FIGS. 9A, 9B and 9C are views simlar to those of FIGS. 8A, 8B and 8C showing a bladder assembly having two bladder arrays, both of which drive only the foot plate of the mattress support.

FIGS. 10-13 are views similar to those of FIGS. 8C and 9C showing other bladder assemblies having either a single bladder array (FIGS. 11-12) or multiple longitudinally distributed bladder arrays (FIGS. 10, 13).

FIG. 14 is a view similar to that of FIG. 9C in which an air conduit extends between first and second bladder array members of the bladder assembly.

FIG. 15 is a view of the foot end mattress support of FIGS. 1-2 in which the actuator system is a mechanical linkage embodied as a scissors jack which acts on a hinge of the foot end mattress support.

FIG. 16 is a view similar to that of FIG. 15 in which the actuator system includes a link extending from a nut component of a leadscrew and connected to the head plate of the foot end mattress support.

### DETAILED DESCRIPTION

The present invention may comprise one or more of the features recited in the appended claims and/or one or more of the following features or combinations thereof.

In this specification and drawings, features similar to or the same as features already described may be identified by reference characters or numerals which are the same as or similar to those previously used. Similar elements may be identified by a common reference character or numeral, with suffixes being used to refer to specific occurrences of the element.

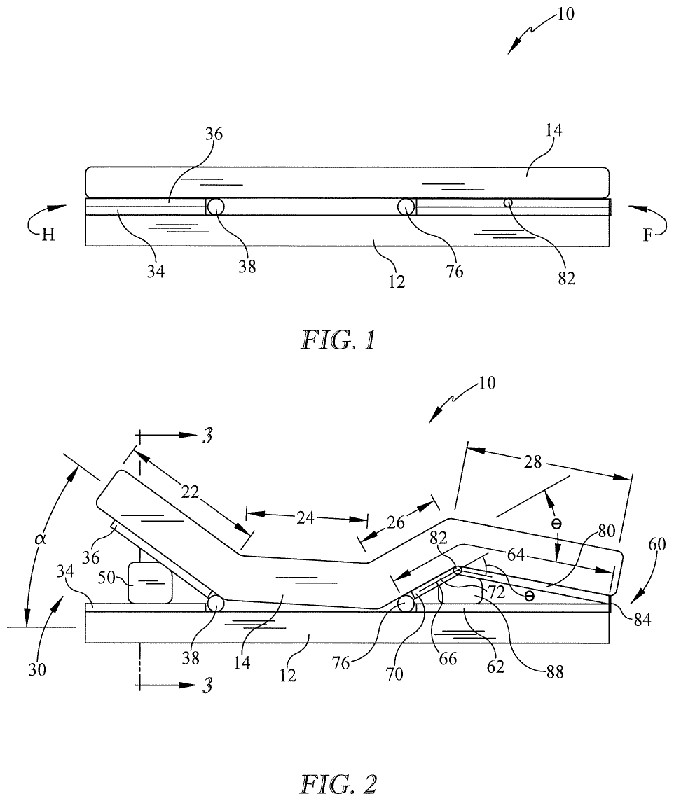

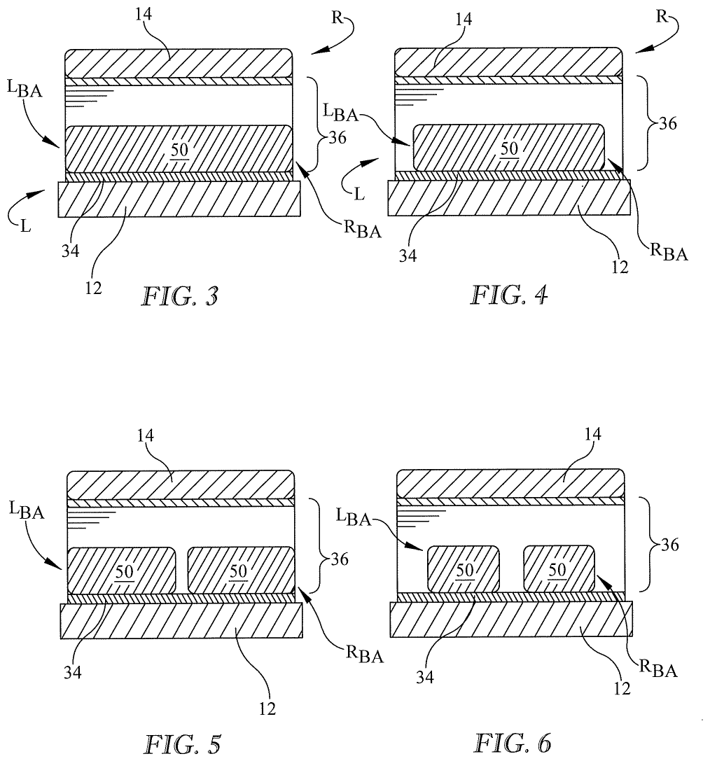

Referring to FIGS. 1 and 2, an illustrative bed assembly 10 extends longitudinally from a head end H to a foot end F and laterally from a left side L (visible in FIGS. 3-6) to a right side R (in the plane of FIGS. 1-2). The bed assembly includes a framework 12 and a mattress 14 supported on the framework. The mattress has an upper body or torso section 22 corresponding approximately to the torso and head of a supine occupant of the mattress, a seat section 24 corresponding approximately to the occupant's buttocks, a thigh section 26 corresponding approximately to the occupant's thighs, and a calf section 28 corresponding approximately to the occupant's calves and feet. The bed assembly as just described is a conventional bed assembly of the type readily available to consumers for use in their homes.

FIGS. 1-2 also show a head end mattress support 30. The head end mattress support is not a component of the conventional bed assembly described above. The head end mattress support is positionable between the head end of the framework 12 and the head end of the mattress 14, and is shown as so positioned in FIGS. 1 and 2.

The head end mattress support includes a base plate 34 and an upper plate 36 hinged to the base plate at a hinge 38. Referring additionally to FIGS. 3-6, the head end mattress support includes an elevation system 50 between the base plate and the upper plate. The illustrated elevation system is a bladder array 50 having a left side L_{BA} and a right side R_{BA}. The elevation system may be embodied in other ways. In the embodiment of FIG. 3 the bladder array is a single bladder that extends laterally substantially the full width of the bed assembly. In the embodiment of FIG. 4 the bladder array is a single bladder that extends laterally less than the full width of the bed assembly. In the embodiment of FIG. 5 the bladder array is multiple bladders that extend laterally substantially the full width of the bed assembly. In the embodiment of FIG. 6 the bladder array is multiple bladders that extend laterally less than the full width of the bed assembly. As is evident from the foregoing, the phrase “bladder array” encompasses a single bladder as well as multiple, laterally distributed bladders located at a particular longitudinal location along the length of the bed assembly.

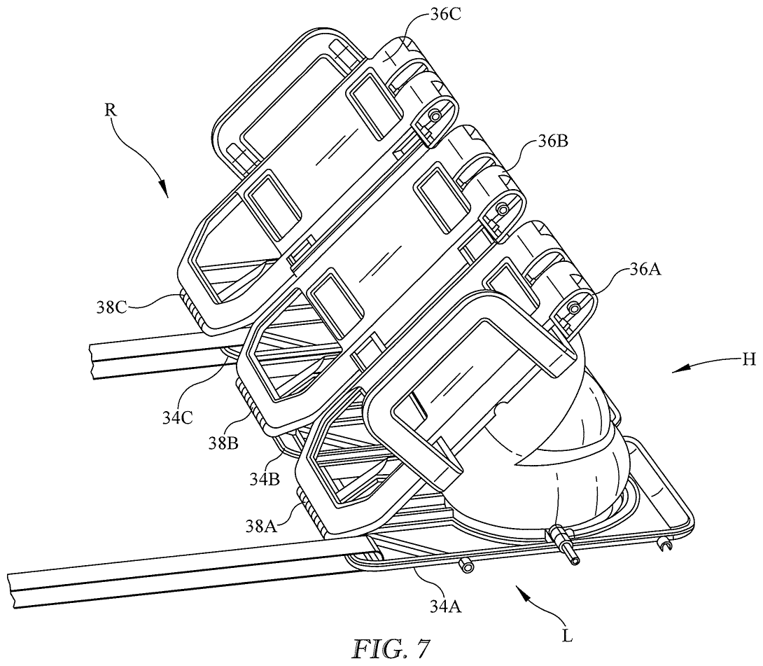

Referring to FIG. 7 the base plate and upper plate of the head end mattress support may be may be laterally segmented or modularized. Unlike FIGS. 4-6 in which the base plate is a single plate and the upper plate is also a single plate, the base plate and upper plate of the embodiment of FIG. 7 is multiple plates, specifically three plates which are laterally linked together. As is evident from the foregoing, the phrase “base plate” encompasses a single base plate as well multiple, laterally distributed base plates linked together. Similarly “upper plate” encompasses a single upper plate or multiple, laterally distributed upper plates linked together.

The modular construction of FIG. 7 permits the mattress support to be customized so that it can be used with conventional beds having different widths. A narrow bed requires fewer modules; a wider bed requires more modules. The modules are constructed so that they can be easily assembled to each other. Further description of the modularization can be found in U.S. Provisional Application 62/739,344.

In operation, elevation system 50 of the head end mattress support may be used to raise and lower (i.e. change the orientation angle α of) the head end portion of the mattress. In embodiments in which the elevation system is a bladder array, the bladder array is inflated/deflated (pressurized/depressureized) to raise/lower the head end portion of the mattress. The pressurizing medium is typically compressed air. The head end mattress support therefore adds to a conventional bed a functionality usually found only in specially designed hospital beds, namely adjustability of the angle α of the torso section of the mattress. A patient who requires this functionality, but who does not need to be hospitalized, can therefore achieve the functionality in his residential bed at a modest cost.

FIGS. 1-2 also show a foot end mattress support 60. The foot end mattress support is not a component of the conventional bed assembly described above. The foot end mattress support includes a base plate 62 and an upper plate assembly 64. The upper plate assembly includes a head plate 66 having a head end 70 and a foot end 72. Head end 70 is hinged to base plate 62 by a first hinge 76. The upper plate assembly also includes a foot plate 80 in tandem with head plate 66. The foot plate is hinged to the foot end of the head plate by a second hinge 82. Second hinge 82 is substantially parallel to first hinge 76 (i.e. the axis of rotation of each hinge is perpendicular to the plane of FIGS. 1 and 2). Hinges, 76, 82 may be of any suitable design. Examples include pin and knuckle hinges and living hinges.

As with the base plate and upper plate of the head end mattress support, the base plate and upper plate of the foot end mattress support may be laterally segmented or modularized. Accordingly, in connection with foot end mattress support 60, the phrase “base plate” encompasses a single base plate as well multiple, laterally distributed base plates linked together. Similarly “upper plate” encompasses a single upper plate or multiple, laterally distributed upper plates linked together.

The mattress support also includes an actuator system 88 between the base plate and the upper plate assembly. The actuator system is analogous to the elevation system 50 described above in connection with the head end mattress support. The actuator system is operable to adjust the upper plate assembly between a planar configuration or profile (FIG. 1) and a nonplanar configuration or profile (FIG. 2). As described in more detail below, the actuator system may take various forms including one or more bladder arrays.

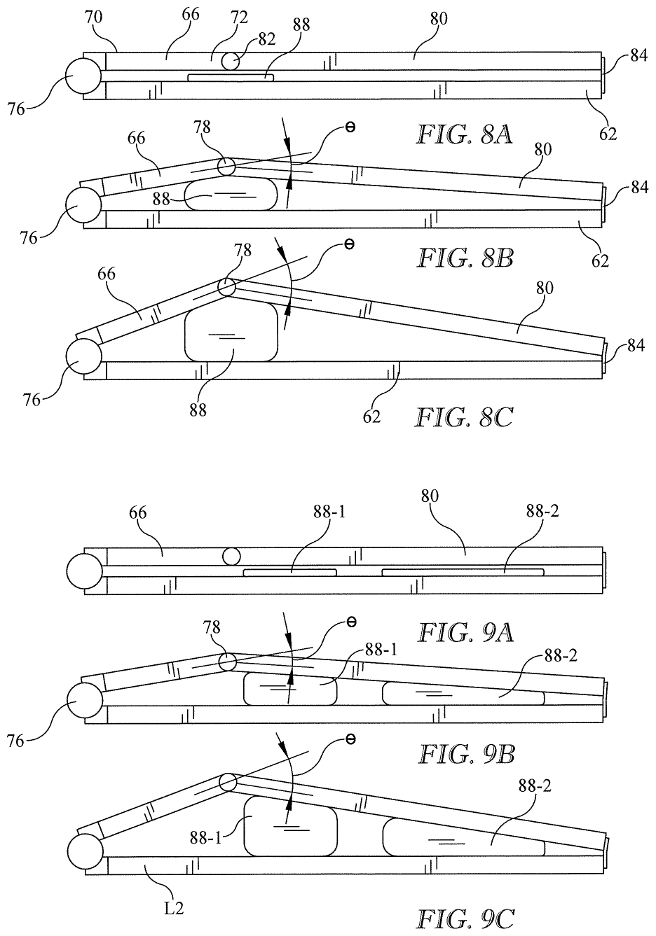

Although foot plate 80 is not hinged to base plate 62, a flexible connector 84 connects the foot plate to the base plate. As seen by comparing FIG. 8C to FIG. 8A, flexible connector 84 flexes to accommodate both the rotation and translation of foot plate 80 relative to base plate 62 as bladder 88 is inflated and deflated. The flexure is also present in the configration of FIG. 8B however the scale of the drawing is too small to show it. The flexible connector helps prevent any unintended displacement or rotation of the foot plate relative to the base plate.

In some embodiments the actuator system is one or more bladder arrays. The phrase “bladder array” encompasses a single bladder and multiple, laterally distributed bladders at a particular longitudinal location, just as in the case of the head end mattress support. In connection with the foot end mattress support the phrase “bladder assembly” refers to a single bladder array (including the limit case in which the bladder array itself is a single bladder) as well as to multiple, longitudinally distributed bladder arrays.

FIGS. 8A, 8B, 8C show the foot end mattress support of FIGS. 1-2 with its bladder array in three different states of inflation. In FIG. 8A the bladder array is deflated. The upper plate assembly is therefore planar. In FIG. 9B the bladder array is partially inflated. The upper plate assembly is therefore nonplanar, and the angle θ defined by the head plate and the foot plate is relatively small. In FIG. 9C the bladder array is fully inflated. The upper plate assembly is therefore nonplanar, and the angle θ defined by the head plate and the foot plate is relatively large and is at its maximum value.

As can be appreciated from FIGS. 1-2 and 8A-8C the foot end mattress support adds to a conventional bed another functionality usually found only in specially designed hospital beds, namely adjustability of the angle θ defined by the thigh and calf sections 26, 28 (FIG. 2 vs. FIG. 1). A patient who requires this functionality, but who does not need to be hospitalized, can therefore achieve the functionality in his residential bed at a modest cost. Although FIG. 2 assigns the same angle θ to both the mattress and the upper plate of the foot end mattress support, in actual practice the angles may not be exactly equal.

Continuing to refer to FIGS. 2 and 8A-8C, the actuation system is a bladder assembly in the form of a single bladder array which acts partly on head plate 66 and partly on foot plate 80. That is, the bladder array extends longitudinally to either side of hinge 78. When inflated, the bladder array exerts a force on and therefore drives both plates.

FIGS. 9A-9C show a foot end mattress support in which the bladder assembly includes a first bladder array 88-1 and a second bladder array 88-2, both of which act on and drive the foot plate, and neither of which act on and drive the head plate. In other words the bladder assembly acts exclusively on the foot plate even though the bladder assembly indirectly causes a change of orientation of the head plate in response to the change of orientation of the foot plate.

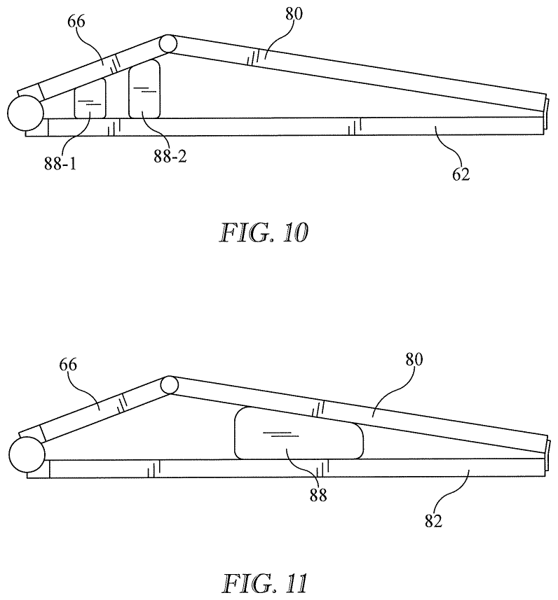

FIG. 10 shows a foot end mattress support in which the bladder assembly includes a first bladder array 88-1 and a second bladder array 88-2, both of which act on and therefore drive the head plate, and neither of which act on or drives the foot plate. In other words the bladder assembly acts exclusively on the head plate even though the bladder assembly indirectly causes a change of orientation of the foot plate in response to the change of orientation of the head plate.

FIG. 11 shows another single member (i.e. single bladder array) limit case of a bladder assembly. The bladder assembly acts on the foot plate, but not on the head plate. In other words the bladder assembly acts exclusively on the foot plate even though the bladder assembly indirectly causes a change of orientation of the head plate in response to the change of orientation of the foot plate.

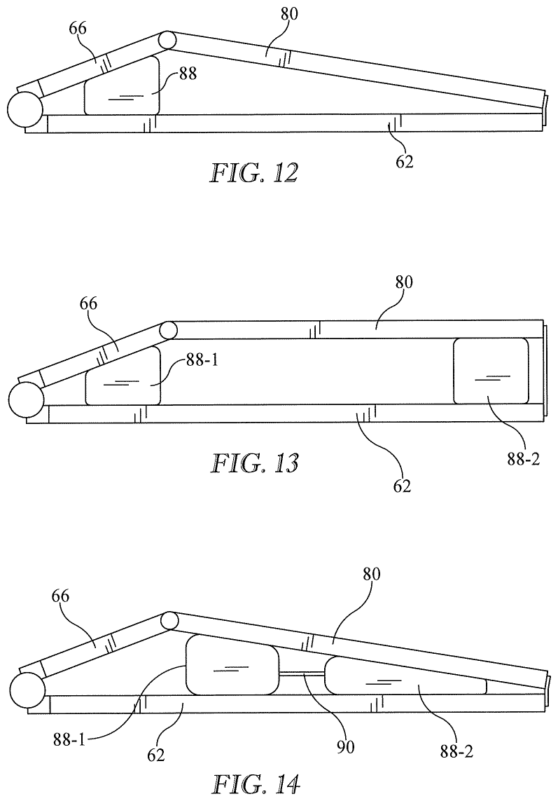

FIG. 12 shows another single member (i.e. single bladder array) limit case of a bladder assembly. The bladder assembly acts on the head plate, but not on the foot plate. In other words the bladder assembly acts exclusively on the head plate even though the bladder assembly indirectly causes a change of orientation of the foot plate in response to the change of orientation of the head plate.

FIG. 13 shows another multiple member bladder assembly in which some of the bladder arrays (in this case a first bladder array 88-1) act only on the head plate, and other of the bladder arrays (in this case a second bladder array 88-2) act only on the foot plate. The inflation states of the bladder arrays are such that the foot plate is horizontal rather than non-horizontal as in other drawings, however second bladder array 88-2 could be less fully inflated thereby yielding a profile like that of FIGS. 8C, 9C and 10-12.

As seen in the multiple bladder array arrangements of FIGS. 9, 10, 13 there is no fluid communication between the bladder arrays of the bladder assembly. Each bladder array is inflated or deflated independently of the other bladder array(s). FIG. 14 shows a variant in which multiple bladder arrays are connected by a conduit 90 so that air is provided to or withdrawn from only one bladder array but serves to inflate or deflate all of the interconnected bladder arrays. Configurations in which some bladder arrays of the bladder assembly are interconnected with each other and in which others are independently inflatable and deflatable may also be employed.

One advantage of an assembly of multiple, longitudinally distributed bladder arrays or of a single bladder array with a large longitudinal extent is that the bladder array may help compensate for any flexure of the upper plate, which may be made of plastic or thin metal.

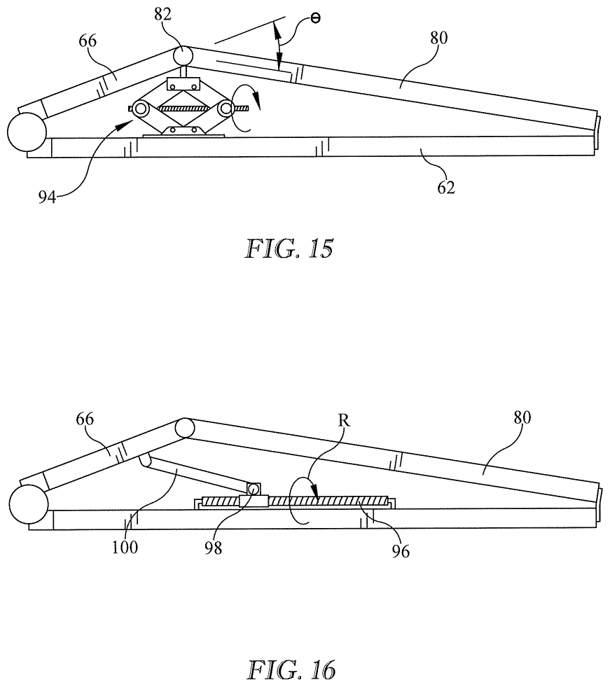

FIG. 15 shows an actuator system embodied as a mechanical linkage, specifically a scissors jack 94. The jack acts directly and exclusively on second hinge 82; it does not act on either panel 66 or 80. As the jack elevates or lowers the second hinge, the angle θ defined by the head plate and foot plate changes. The jack may be operated by any convenient means (not shown), e.g. by way of an electric motor.

FIG. 16 shows another mechanical linkage playing the role of the actuator system. The linkage is another form of a jack which includes a leadscrew 96, a nut 98 threaded onto the leadscrew, and a link 100 extending from the nut to the underside of head panel 66. Rotation of the leadscrew (e.g. as shown by rotational arrow R) causes nut 98 to travel along the leadscrew thereby raising or lowering head panel 66. Link 100 directly drives head panel 66 thereby indirectly influencing the orientation of foot panel 50. The jack may be operated by any convenient means (not shown), e.g. by way of an electric motor.

Although this disclosure refers to specific embodiments, it will be understood by those skilled in the art that various changes in form and detail may be made without departing from the subject matter set forth in the accompanying claims.

We claim:

1. A mattress support comprising:
a base plate;
an upper plate assembly comprised of:
a head plate having a head end and a foot end, the head end hinged to the base plate by a first hinge, and
a foot plate in tandem with the head plate and hinged to the foot end of the head plate by a second hinge which is parallel to the first hinge; and
an actuator system between the base plate and the upper plate assembly, the actuator system operable to adjust the upper plate assembly between a planar configuration and a nonplanar configuration.

2. The mattress support of claim 1 wherein the actuator system is a single member bladder assembly which directly drives both the head plate and the foot plate.

3. The mattress support of claim 1 wherein the actuator system is a single member bladder assembly which directly drives only the head plate or only the foot plate.

4. The mattress support of claim 1 wherein the actuator system is a multiple member bladder assembly.

5. The mattress support of claim 4 wherein the bladder assembly drives only the head plate or only the foot plate.

6. The mattress support of claim 4 wherein at least one of the bladder arrays of the bladder assembly drives only the head plate, and other bladder array(s) of the bladder assembly drive only the foot plate.

7. The mattress support of claim 1 wherein the actuator system acts exclusively on the second hinge.

8. The mattress support of claim 1 including a flexible connector connecting the foot plate to the base plate.

9. The mattress support of claim 1 wherein the actuator system is a mechanical linkage.

10. The mattress support of claim 1 wherein the actuator system is a jack.
